(19) United States
(12) Patent Application Publication
(10) Pub. No.: US 2010/0049397 A1
(43) Pub. Date: Feb. 25, 2010

(54) FUEL EFFICIENT ROUTING

(75) Inventors: Kungwel Liu, Chandler, AZ (US); Susan S. Chen, Chandler, AZ (US); Merlin J. Smith, Chandler, AZ (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., Camana Bay (KY)

(21) Appl. No.: 12/256,712

(22) Filed: Oct. 23, 2008

Related U.S. Application Data
(60) Provisional application No. 61/091,211, filed on Aug. 22, 2008.

(51) Int. Cl. G01C 21/36

(52) U.S. Cl. 701/33; 701/201

(57) ABSTRACT

Techniques are described to determine a fuel-efficient route for a vehicle. In an implementation, a determination is made, based on the one or more characteristics of the vehicle, as to a route between an identified location and a designated location that would cause the vehicle to consume a lesser amount of fuel when traveling between the identified and designated locations. Accordingly, the route may be represented, such as for use in navigating to the designated location.

### RELATED APPLICATION

This Application, under the provisions of 35 U.SC. §119(e), claims the benefit of and priority to U.S. Provisional Application Ser. No. 61/091,211, filed Aug. 22, 2008, and entitled “Fuel Efficient Routing”, the disclosure of which is incorporated herein by reference in its entirety.

### BACKGROUND

Global Positioning Systems (GPS) have been developed to provide accurate positioning data. In traditional GPS systems, a receiver is used to capture input signals to identify a location of the receiver with respect to one or more GPS signal sources, such as satellites. In this manner, a device including the receiver may be used to navigate from the identified location to a designated location.

When the device is provided with a library of roadways (such as streets, avenues, boulevards, paths, highways, expressways, alleys, trails) the device may be capable of indicating a route between the identified and designated locations. For example, upon accepting an end point, the device may access a library containing roadway data to indicate which roadways can be used to reach the designated location. However, the indicated route between the identified and designated locations is often limited to the route having the shortest overall distance or the route that offers the shortest overall travel time. Accordingly, a user of the device may be limited to selecting the route with the shortest overall time or the shortest overall distance. Using a device configured to provide a route based on the overall time or distance may be inefficient.

### SUMMARY

Techniques are described to determine based on one or more characteristics of a vehicle which route would cause the vehicle to consume a lesser amount of fuel when compared to other routes. In an implementation, a determination is made, based on the one or more characteristics of the vehicle, as to which route between an identified location and a designated location would cause the vehicle to consume a lesser amount of fuel when traveling between the identified and designated locations. Accordingly, the route associated with the lesser fuel amount may be represented, such as for use in navigating to the designated location.

This Summary is provided solely to introduce subject matter that is fully described in the Detailed Description and Drawings. Accordingly, the Summary should not be considered to describe essential features nor be used to determine scope of the claims.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an exemplary positioning system environment that is operable to perform fuel efficient routing.

FIG. 2 is an illustration of a system in an exemplary implementation showing the position-determining device of FIG. 1 in greater detail as employing fuel efficient routing.

FIG. 3 is an illustration of a system in an exemplary implementation showing the position-determining device of FIG. 1 in greater detail as employing fuel efficient re-routing.

FIG. 4 is an illustration of a system in an exemplary implementation showing the position-determining device of FIG. 1 in greater detail as receiving data from a vehicle's onboard computer.

FIG. 5 is an illustration of a system in an exemplary implementation showing web access to routing data and/or historical data for a journey.

FIGS. 6A-D are illustrations of exemplary graphical user interfaces implemented by the position-determining device of FIG. 1

FIG. 7 is a flow diagram depicting a procedure in an exemplary implementation in which fuel efficient routing techniques are used to route a vehicle.

### DETAILED DESCRIPTION

### Overview

Traditional routing techniques typically offer the option to select a route offering the shortest overall time or the shortest overall distance between a starting location and an end location. However, routing based on these factors limits the number of routes that may be offered between the starting and ending locations. For example, a GPS device offering a route with the shortest overall time may provide a route that is physically longer but travels over highways that have higher speed limit. By routing based on time or distance, other factors impacting an overall efficiency of a journey between the starting and ending locations are not considered.

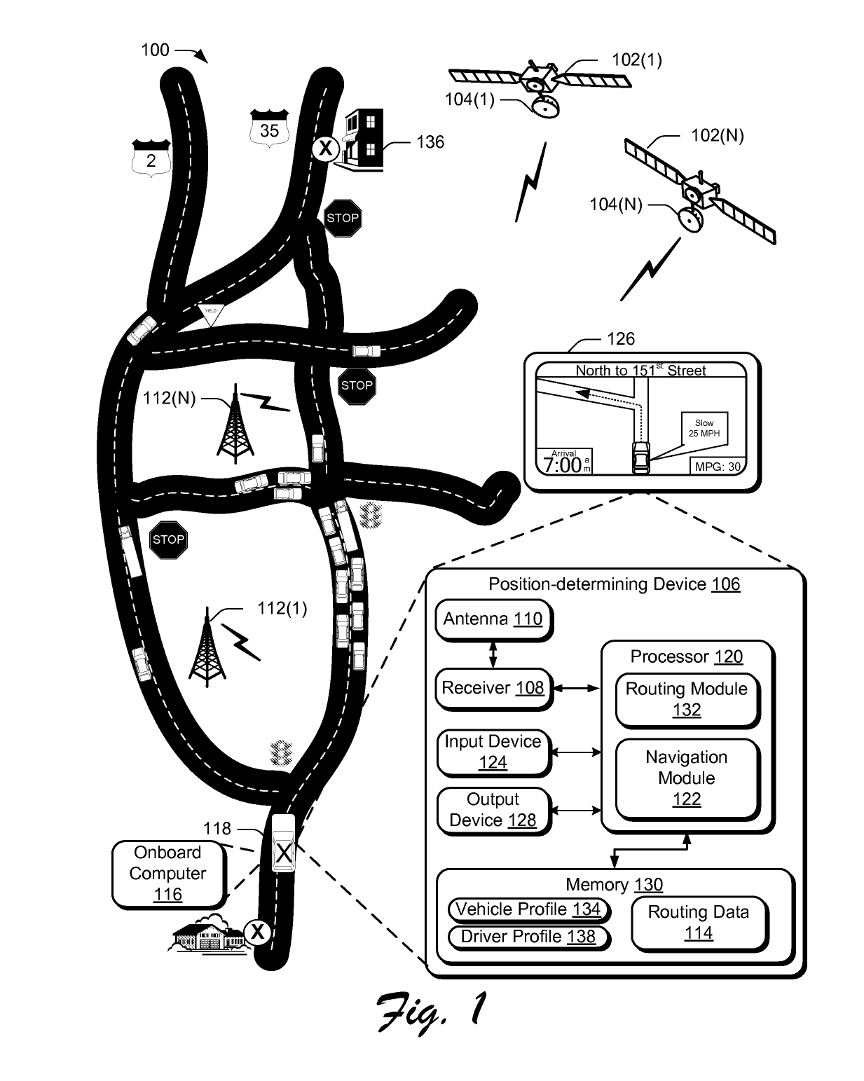

Accordingly, fuel efficient routing techniques are described. In an implementation, a determination is made, based on a vehicle profile, as to a route associated with a least fuel consumption amount. For example, the determination may include calculating which route is associated with the least fuel consumption based on a vehicle type and/or various routing factors that are associated with a plurality of road segments or other roadway or route elements disposed between a location identified by a Global Positioning System input, or any other starting location including locations defined by a user, and a designated location. A representation of the route determined to be associated with the least fuel consumption amount may be provided, such as by presenting the representation of the route visually for use by a driver of a vehicle. A variety of other examples are also contemplated, further discussion of which may be found in relation to the following figures that show additional features and aspects that may be implemented by a position-determining device configured to implement fuel efficient routing as discussed in relation to FIGS. 1-5.

In the following discussion, an exemplary environment is first described that is operable to implement fuel efficient routing techniques. Exemplary procedures are then described which may employed in the exemplary environment, as well as in other environments without departing from the spirit and scope thereof. Although the fuel efficient routing techniques are described in relation to a GPS position-determining environment with an automobile type vehicle, it should be readily apparent that these techniques may be employed in a variety of environments, such as by motorcycles, and so on.

### Exemplary Environment

FIG. 1 illustrates an exemplary positioning system environment 100 that is operable to implement fuel efficient routing. A variety of positioning systems may be employed to provide position-determining techniques, an example of which is illustrated in FIG. 1 as a Global Positioning System (GPS). The environment 100 can include any number of position-transmitting sources 102(1)-102(N), such as a satellite including one or more antennas 104(1)-104(N), a land based station, an aircraft, and so on. The position-transmitting sources 102(1)-102(N) may be capable of transmitting a signal that can be used to identify the location of a position-determining device 106 relative to the position-transmitting sources providing the signals. In this manner, the location of the position-determining device 106 can be identified and the position-determining device 106 can navigate from the identified location. For example, the position-determining device 106 may be a GPS enabled device that includes a receiver 108 that is configured to receive the signals via an antenna 110 from the position-transmitting sources 102(1)-102(N). Although a position-determining device 106 is described with a land based vehicle environment, such as an automobile, the position-determining device 106 may be implemented in a variety of environments, such as marine-environments and/or airborne-environments.

Position-determining functionality, for purposes of the following discussion, may relate to a variety of different navigation techniques and other techniques that may be supported by “knowing” one or more locations. For instance, position-determining functionality may be employed to provide location data, timing data, speed data, and a variety of other navigation-related data. The position-determining device 106 may be configured in a variety of ways to perform a wide variety of navigation related functions. For example, the positioning-determining device 106 may be configured for vehicle navigation as illustrated, aerial navigation (e.g., for airplanes, helicopters), marine navigation, personal use (e.g., as a part of fitness-related equipment), and so forth. Accordingly, the position-determining device 106 may include a variety of devices to determine the position of the position-determining device 106 using one or more of the techniques previously described. In various embodiments, the position-determining device 106 is configured as a portable navigation device including a portable and handheld housing.

While a GPS system is described in this document, it should be apparent that a wide variety of other positioning systems may also be used, such as terrestrial based systems (e.g., wireless-telephony systems or data systems that broadcast position data from cellular towers), wireless networks that transmit positioning signals, and so on. For example, positioning-determining functionality may be implemented through the use of a server in a server-based architecture, from a ground-based infrastructure, through one or more sensors (e.g., gyros or odometers), and so on. Other exemplary systems include, but are not limited to, a Global Orbiting Navigation Satellite System (GLONASS), a Galileo navigation system, or other satellite navigation system.

One or more routing data sources may be used to provide routing data 114 to the position-determining device 106. For example, a server including the routing data 114 may provide routing data via one or more transmitters 112(1)-112(N), terrestrial cellular towers, or other wireless networks for use by the position-determining device 106. Although, the routing data sources may be associated with the position-transmitting sources, in other instances the routing data source and/or the transmitter are independent from the position-transmitting sources.

The position-transmitting sources 102(1)-102(N) and the transmitters 112(1)-112(N) associated with the routing data source may implement a common communication technology or use independent communication technologies. Accordingly, while the position-determining device 106 is illustrated as including a receiver 108, in additional examples the position-determining device includes multiple antennas and receivers to accept signals using different communication technologies.

The routing data source and/or the transmitters 112(1)-112(N) may communicate routing data 114 in a variety of ways. For example, responsive to the position-determining device 106 requesting routing data 114, the routing data source may use the transmitters 112(1)-112(N) to communicate a burst of routing data, stream the routing data based on the location of the position-determining device 106, provide routing data in a request-response manner, and so on.

Exemplary routing data 114 may include one or more of real-time data and/or historical data. Routing data 114 may be considered as factors that may impact fuel consumption.

Real-time data may include, but is not limited to, weather conditions (e.g., temperature, precipitation), road conditions (e.g., construction), and real-time traffic conditions. For example, the routing data source may access traffic control and traffic detection systems maintained by a municipality or other governmental entity to indicate how fast traffic is moving on a segment of a street.

Historical data may include, but is not limited to, traffic patterns, route conditions (e.g., train schedules, the number of stop signs, number of turns, the type of turns, electronic traffic controls, yield signs, and so on), roadway classifications (e.g., surface streets, residential streets, expressways), and topographic data (such as rolling hills, steep, flat). The historical data may be correlated with routing data 114 to the designated location, with a point in time at which a route is being determined, and so on. The routing data 114 may include routing factors that are associated with fuel consumption, e.g., a stop, a change in elevation, and so on.

The position-determining device 106 may include additional antennas, receivers, and/or transmitters for communicating with other devices, such as an onboard computer 116 (e.g., an engine diagnostic system) included in a vehicle 118 associated with the position-determining device 106. For example, the position-determining device 106 may include a BLUETOOTH (Bluetooth Sig, Inc., Bellevue, Wash.), ANT (Dynastream Innovations, Inc. Chochrane, Alberta, Canada), and/or otherwise wireless receiver and/or transmitter for communicating with the vehicle's onboard computer 116. In other instances, the position-determining device 106 may be hardwired to the onboard computer 116.

As illustrated the receiver 108 and the antenna 110 are communicatively coupled to a processor 120. A navigation module 122, an input device 124 (e.g., a touch screen 126, buttons, microphone, and so on), an output device 128 (e.g., a touch screen 126 that displays a user interface (e.g., a graphical user interface), speakers and/or data connection) and a memory 130 are also illustrated as being communicatively coupled to the processor 120.

The processor 120 is not limited by the materials from which it is formed or the processing mechanisms employed therein, and as such, may be implemented via semiconductor(s) and/or transistors (e.g., electronic integrated circuits (ICs)), and so forth. Although a single memory 130 is shown, a wide variety of types and combinations of memory may be employed, such as random access memory (RAM), hard disk memory, removable medium memory (e.g., the memory 130 may be implemented via a slot that accepts a removable memory cartridge), and other types of computer-readable media.

Although the components of the position-determining device 106 are illustrated separately, it should be apparent that these components also may be further divided (e.g., the output device 128 may be implemented as speakers and a display device) and/or combined (e.g., the input and output devices 124, 128 may be combined via the touch screen 126) without departing from the spirit and scope thereof.

The signals from the position-transmitting platforms 102(1)-102(N) can be communicated to the processor 120 for processing by the navigation module 122, which is illustrated as being executed on the processor 120 and is storable in the memory 130. The navigation module 122 is representative of functionality that “knows” a location, such as by processing the signals obtained from the position-transmitting platforms 102(1)-102(N) to provide the position-determining functionality previously described, such as to locate the position-determining device 106, speed, time, and so forth.

The navigation module 122, for instance, may be executed to use position data stored in the memory 130 to show a current position on a map, and so on. The navigation module 122 may also be executed to provide other position-determining functionality, such as to determine a current speed, calculate an arrival time, and so on. A wide variety of other examples are also contemplated.

As illustrated the position-determining device 106 includes a routing module 132. The routing module 132 is representative of functionality to determine which route is associated with a least fuel consumption amount. For example, the routing module 132 may be configured to determine fuel consumption amounts that are associated with various road segments, roadway elements, road classes, route elements, and/or routes to the designated location and then permit representation of the route that is associated with the least fuel consumption based on a vehicle profile 134. The routing module 132 may make the determination by calculating, base on the vehicle profile 134, which route may consume the least amount of fuel for the route. For the purposes of the present disclosure, fuel may refer gasoline, diesel, hydrogen, other forms of energy (e.g., electrical energy stored in a battery), and so on. In some embodiments, the routing module 132 can be stored in the memory 130 or other computer-readable storage medium until called on.

The routing module 132 may use routing data 114 from one or more of the memory 130, the routing data source, or the like to determine which route between the identified and designated locations is associated with the least fuel consumption amount. For example, the routing data 114 may be stored in a database included in memory 130. The routing module 132 may consider the routing data 114 as routing factors that can be used by the routing module 132 to determine a fuel consumption amount for a particular route or road segment.

Fuel consumption amounts for a particular route may be based upon associating a routing factor, a combination of routing factors, and so on. For example, the routing module 132 in making the determination may consider a street having a steep uphill grade and several stops in combination as the overall impact of the routing factors (e.g., the stops and the uphill grade) may be magnified in comparison to independently considering the routing factors, e.g., more fuel may be consumed by starting from a stop on a hill in comparison to traveling up the hill and then restarting from a stop on level ground. In some implementations, combinations of routing factors may be pre-associated by the routing data source or pre-associated in the memory 130. The routing factors may additionally correspond to other navigation-related information, including but not limited to: average speed along a road segment; maximum speed along a road segment; posted speed limits for a road segment; historical traffic information for a road segment; real-time traffic information for a road segment; time-based information including traffic information; combinations thereof, and the like.

The routing module 132 and/or the routing data source may assign the routing factors values based on the impact of the routing factor on fuel consumption, e.g., values indicative of fuel consumption for a particular routing factor. For example, a stop sign on a street with a 45 (mph) mile per hour speed limit may be assigned a higher weighted value than a stop sign on a street with a 30 mph speed limit. By assigning values to the routing factors, the routing module 132 may consider the impact of the individual routing factors on fuel consumption as part of determining which route is associated with the least fuel consumption amount.

Having discussed the environment and the position-determining device 106 within the environment, additional implementations will be discussed and additional features of the position-determining device 106 will be described.

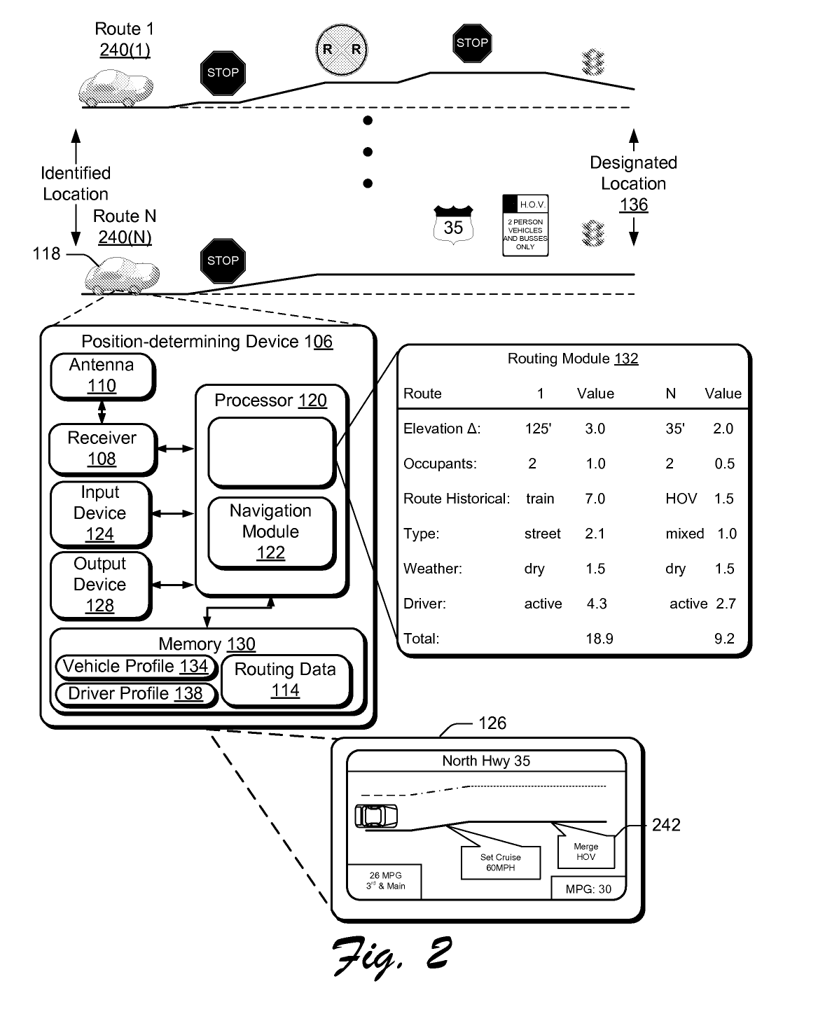

FIG. 2 is an illustration of a system 200 in an exemplary implementation showing the position-determining device 106 of FIG. 1 in greater detail employing fuel efficient routing. For example, the position-determining device 106 may implement fuel efficient routing techniques as part of determining which route to the designated location is associated with the least fuel consumption amount.

Consider for instance a trip between a location identified using the signals from position-transmitting sources (e.g., a user's home) and a designated location, such as a restaurant 136, as shown in FIGS. 1 and 2. In response to receiving an input for directions to the restaurant 136, the position-determining device 106 may send a request for routing factors to one or more of the routing data source, obtain the routing factors from the memory 130, and so on. The request may include data, such as the location of the position-determining device 106, the designated location (e.g., an endpoint), what data is to be obtained, and so on.

When a client-side approach is to be used, the routing module 132 may obtain routing data 114 from one or more of the memory 130 or the routing data source for use in determining which route is associated with the least fuel consumption amount. The routing module 132 may base the determination as to which route is associated with the least fuel consumption on one or more of the vehicle profile 134, a driver profile 138, and/or routing data 114. For example, in response to receiving a designated location associated with a previous journey, the routing module 132 may access the memory 130 for routing data 114 including historical data from a previous journey, e.g., fuel consumption, average speed, time, and so on. In the foregoing example, the data from the previous journey may be part of one or more of the vehicle profile 134, the driver profile 138, or routing data 114.

The routing module 132 may request routing data 114 from the routing data source or routing data 114 can be periodically loaded in to the memory 130 by connecting a jump drive, syncing the position-determining device 106 to the routing data source, and so on. For example, a removable memory device may be connected to the position-determining device 106 to update which routing factors are to be considered in making the determination.

In one or more embodiments, the routing module 132 may be configured to heuristically determine which route is associated with the least fuel consumption amount, such as based on one or more of the vehicle profile 134, routing factors, and/or the driver profile 138. For example, the routing module 132 may adaptively learn which route is to be associated with the least fuel consumption amount from among the routes associated with previous journeys. Thus, if a driver has a habit or tendency of rapidly accelerating from a stop, the routing module 132 may adapt which route is determined to be associated with the least fuel consumption to eliminate stops.

The vehicle profile 134 may include one or more of data corresponding to a vehicle type for the vehicle 118, data specific to a particular vehicle (e.g., data from the onboard computer 116), and so on. For instance, the vehicle profile may include characteristics that are associated with fuel consumption. Exemplary characteristics include, but are not limited to, engine size (e.g., V-6, V-8), transmission (e.g., manual, automatic), accessories (air conditioning), vehicle features (e.g., regenerative breaks, hybrid electrical/internal combustion), passenger information, weight/towing, optimum speeds for fuel efficient travel, and so on. The routing module 132 may consider one or more of the characteristics as part of making the determination. For example, if the vehicle profile 134 indicates that the vehicle includes regenerative breaks, the routing module 132 may take this characteristic into account in determining which route is associated with the least fuel consumption. As should be appreciated, the vehicle profile 134 may include customized characteristics that allow a user to select, add, and/or adjust characteristics. In some implementations, the vehicle profile may be obtained from a variety of sources, e.g., from a vehicle manufacturer, from a governmental agency, a third party data source, and so on. For example, a web browser associated with the device 106 may be utilized to access content associated with vehicle profiles to allow a user to download a vehicle profile specific to his or her vehicle.

The position-determining device 106, as part of the request for routing data, may indicate one or more of the characteristics from the vehicle profile. In response, the routing data source may provide routing data that is specific to the indicated characteristics.

The driver profile 138 may include data for a specific driver (e.g., a remote control used to unlock the vehicle may be used to identify the driver) or based on user self-identification. In other embodiments, the driver profile 138 may represent the driver history (e.g., habits) for a composite driver associated with the vehicle 118 and/or the position-determining device 106. For example, the driver profile may include a driver's average speeds over specific roads or routes, average speeds over various road classes (e.g., average speed over highways, over side streets, etc.), average speeds at certain times, acceleration and deceleration patterns, combinations thereof, and the like.

As illustrated in FIG. 2 several routes (routes “1” through “N” are numbered 240(1) and 240(N) respectively) exist between the identified starting location and the designated destination location. Routing factors, such as a number of stop signs on identified road segments, the terrain for the identified road segments (e.g., a cumulative altitude change over one or more road segments), average speed limit, historical travel speeds, traffic information, road class information, and any of the other factors discussed herein, may be utilized to identify a fuel-efficient route between the identified starting location and the designated destination location. The routing factors may be associated with one or more road segments that comprise a portion of any one of the possible routes between the starting location and the destination location.

As illustrated, route “1” 240(1) may represent a route over surface streets including two full stops (indicated by two stop signs), a railroad crossing, a electronic traffic control signal (indicated by a stoplight), and various terrain changes. In comparison, route “N” 240(N) may represent roadways with a mixed classification (e.g., surface streets and highways), including a full stop (indicated by a stop sign), a highway segment that offers a high occupancy vehicle (HOV) lane, and an electronic traffic control signal (indicated by a stoplight). While route “1” 240(1) and route “N” 240(N) both start at the identified location (e.g., home) and end at the designated location (e.g., the restaurant 136), the road segments corresponding to the routes offer different routing factors, such as the HOV lane, highway segment, surface streets, and so on.

The routing module 132 may determine which route is associated with the lowest fuel consumption amount by implementing an algorithm that calculates a fuel consumption amount based on numerical values assigned to one or more of road segments, routing factors, route elements, and so on. For example, routing data 114 may include a value associated with the fuel consumption associated with a routing factor. As a result, the routing module 132 may determine which route is associated with the least fuel consumption amount by calculating the routing factor's impact on fuel consumption along various road segments along the route. Additionally or alternatively, the routing module 132 may determine the most fuel-efficient route based on expected travel speeds associated with various road segments and/or road categories expected to be encountered over a potential route, as is discussed in more detail below. For example, to identify a route by analyzing a plurality of road segments between the starting location and the destination location, the algorithm may take into consideration the traveling speed of a road segment (shortest route time), road segment length (shortest route distance), and the routing factors discussed above, to select appropriate road segments to comprise portions of the route.

The routing module may consider the routing factor's fuel consumption impact based on one or more characteristics included in the vehicle profile 134. For example, a stop may have more of an impact for a large internal combustion truck than on a hybrid vehicle that includes a regenerative braking system, e.g., a breaking system that can recover energy as part of slowing the vehicle. In some instances, the characteristics included in the vehicle profile can be assigned “multiplier value” that is used when calculating the fuel consumption for a particular route based on the vehicle profile 134. For example, if a stop is assigned a value of “1.0”, a V-8 engine may a “multiplier value” of “2.3” as large amount of fuel may be consumed in accelerating from the stop in comparison to hybrid vehicle that may have a multiplier value of “0.8” due to the inclusion of regenerative breaks. The driver profile may include corresponding multiplier values that can be calculated separately or included as part of calculating the impact of the characteristics included in the vehicle profile on fuel consumption.

This calculation may also take into account one or more of the vehicle profile 134, data derived from position-transmitting source signals and/or the driver profile 138. In this way, changes in routing factors may be adjusted, e.g., a value for an electronic traffic signal's may be changed when the timing for the electronic traffic signal is changed. Additionally, the impact of the vehicle and/or the driver may be considered. For example, while route traveling over a highway may be associated with the least fuel consumption amount for an internal combustion vehicle, a shorter surface street route may be associated with the least fuel consumption amount for a hybrid vehicle.

As will be appreciated, the routing module 132 may accept user input for inclusion in the determination. For example, in response to receiving a user input, via a touch screen 126, that designates that the route is to include a stop at a gas station having E85 gasoline (a high ethanol content fuel that is not commonly stocked in some regions), the routing module 132 may designate a particular route that passes by a fuel station with E85 gasoline.

In some implementations, the routing module 132 may make the determination in a stepwise manner. For example, the routing module 132 may determine a first portion of the route and then make a determination as to subsequent portion of the route. An example of the foregoing may occur when the journey is of sufficient length of time such that a routing factor may change, e.g., weather or traffic. A stepwise determination may be implemented when the position-determining device's processing and/or communication capabilities are limited in comparison to the data to be processed/communicated for the determination procedure.

Upon determining which route is associated with the least fuel consumption amount, the position-determining device 106 may represent the route. Exemplary representations included, but are not limited to, providing a visual representation, providing an audio representation (e.g., a set of spoken instructions), and so on. For example, a touch screen 126 may be used to provide a visual representation of the determined route. The representation may indicate fuel consumption data, e.g., fuel consumption rates associated with roadway segments, the availability of a fuel source, the monetary cost (in spent fuel) to travel the route based on real-time or user-entered fuel prices, and so on. When the route is represented visually, different patterns or colors may be used to indicate different fuel consumption rates. Audible cues may be used independently or in conjunction with the visual representation for substantially similar purposes.

In one or more embodiments, the routing module 132 may provide a real-time recommendation for reducing fuel consumption. For example, the routing module 132 may recommend a course of action that is calculated to reduce the real-time fuel consumption for the vehicle 118. Examples include, but are not limited to, setting a cruise control, coasting, or reducing the vehicle's acceleration. In this manner, the position-determining device 106 may be used as a training tool for providing real-time feedback to the user. For example, an audible cue may be provided to prompt the user as to reduce an acceleration rate. In one or more examples, the position-determining device 106 may provide a contour map that indicates a “sweet spot” (e.g., a preferred operating range) based on characteristics of the vehicle, routing factors, and so on. For instance, in addition to presenting a real-time fuel consumption rate for the vehicle, a higher or lower tone may be used to prompt the user to “speed-up” or “slow-down” to conserve fuel. A moving symbol may be displayed on the contour map to indicate the real-time fuel consumption position.

The recommendation may be provided in a similar manner as the representation of the route and may be associated with a location identified from the signals provided by the position-transmitting sources. Thus, when a visual display is presented, a popup window or balloon 242 may be used to display the recommendation. The recommendation may be eliminated once the recommendation is no longer valid or a new direction is issued. For example, a recommendation to set the cruise control may be eliminated once an instruction to make a turn is issued. In other situations, an audible recommendation can be provided while the route is represented visually. A variety of other examples are also contemplated.

When a server side approach is to be implemented, the position-determining device's request may include the vehicle profile 134 and/or the driver profile 138. For example, in response to the request, the routing data source may perform initial calculations and so on that may be transmitted for use by the routing module 132. In some embodiments, the routing data source may perform the functions of the routing module 132.

A server side approach can be used when the position-determining device 106 is to have “thin” capabilities, such as limited processing and/or memory capabilities in comparison to the determination procedure. In the foregoing example, the routing data source may determine a route associated with the least fuel consumption amount (e.g., the highest fuel efficiency) based on the vehicle profile 134 and return the result to the position-determining device 106.

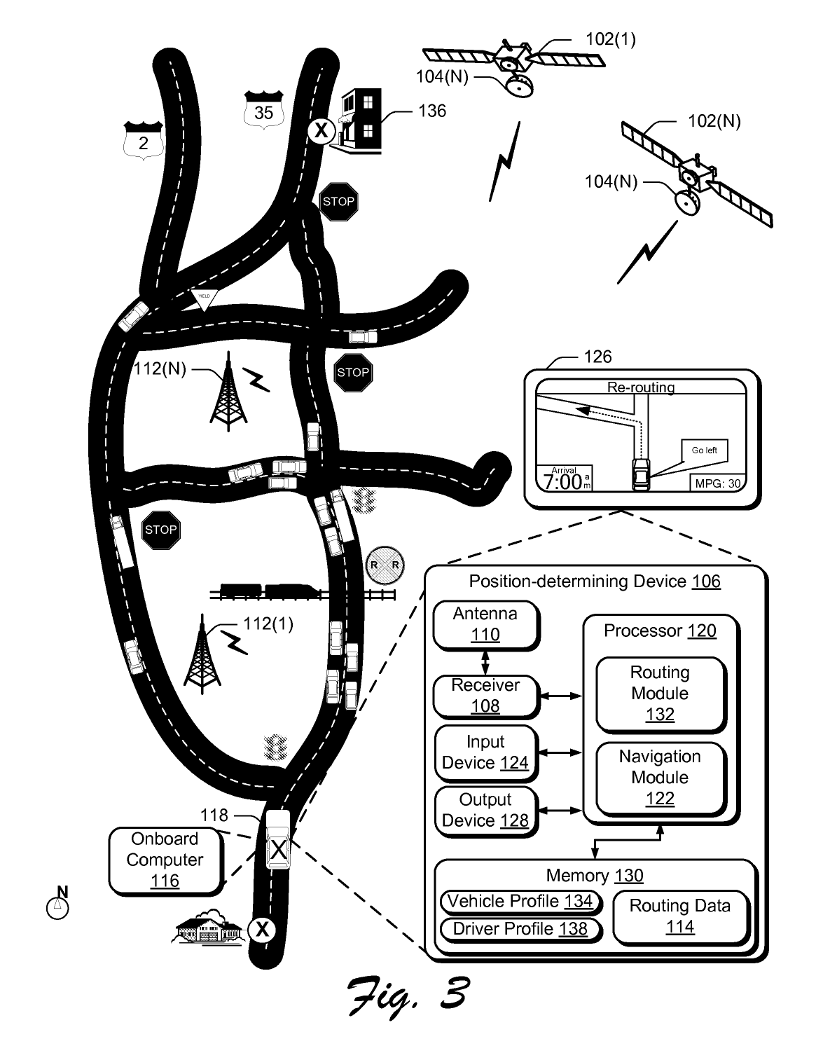

As illustrated in FIG. 3, the position-determining device 106 can be configured to represent a different route responsive to making a determination that the represented route no longer is associated with the least fuel consumption amount. For example, based on data derived from the position-transmitting source signals, the routing module 132 may determine that re-routing is appropriate, e.g., before an intersection or change in course. Based on the determination, the position-determining device 106 may represent a different route that is associated with the least fuel consumption amount at the time of the determination or at a location, e.g., just prior to an intersection that is common to two or more routes. For example, upon receiving notice that a train is passing over a railroad crossing, the position-determining device 106 may use the touch screen 126 to represent the different route to the designated location that avoids the train delay and/or the added fuel consumption. As should be appreciated, the determination may be associated with a particular point in time and/or location along the route, e.g., before an intersection.

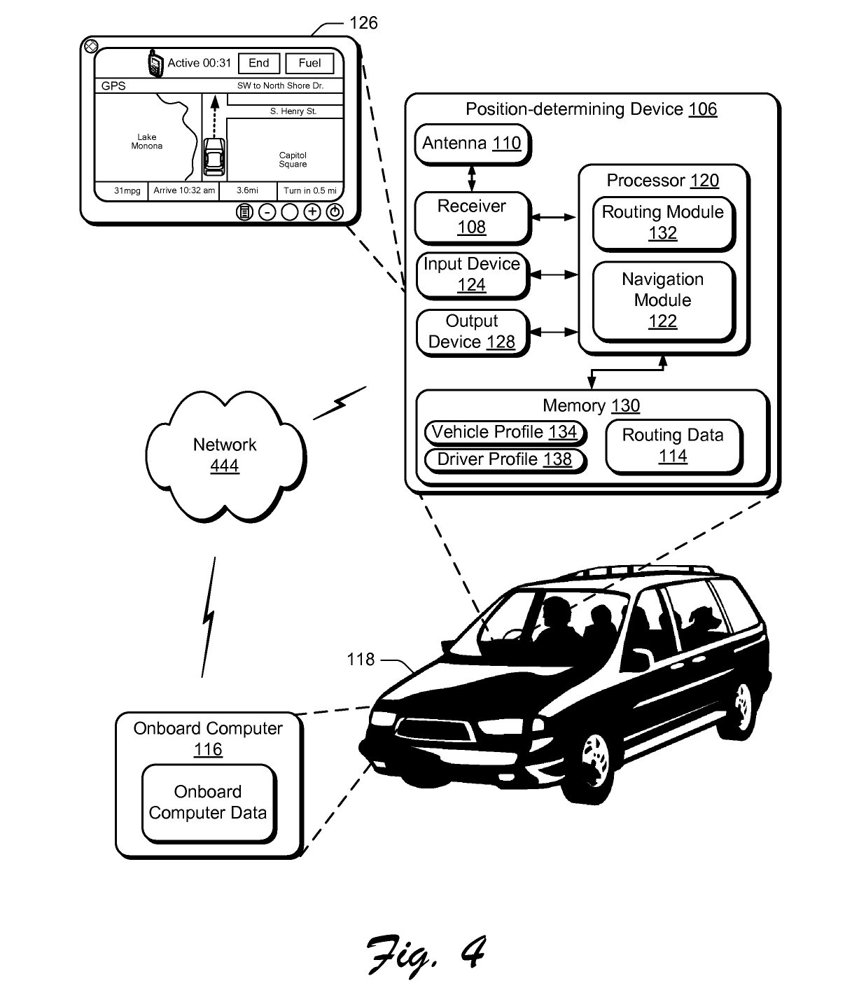

As illustrated in FIG. 4, the position-determining device 106 can be configured to receive data from the vehicle's onboard computer 116. An example of the onboard computer 116 is an on-board diagnostic (OBD) system typically included in a vehicle's engine compartment for vehicles configured for first sale in the United States after 1995, which may present an OBD-I, OBD-1.5, OBD-II, EOBD, EOBD2, and/or other similar diagnostic interfaces. The onboard computer 116 may obtain real-time data associated with the vehicle's fuel consumption. Example data provided by the onboard computer includes, but is not limited to, one or more of fuel system status, calculated load value, engine coolant temperature, fuel pressure, intake manifold pressure, engine speed, vehicle speed, ignition timing spark advance, intake air pressure, mass air flow sensor rate, throttle position sensor, commanded secondary air status, oxygen sensor location, and so on. The data from the onboard computer 116 can be stored in memory 130 and/or uploaded, e.g., to the routing data source for web access. While engine related data is discussed, other sensors may provide data, for example, a camera or other range-finding detector may be used to monitor traffic, determine if acceleration or deceleration is to occur, and so on.

Suitable networks for communications between the position-determining device 106 and the onboard computer 116, included but are not limited to, a network 444, such as a wireless network (e.g., a BLUETOOTH network or ANT network) or other wireless connections, the position-determining device 106 may use a physical connection (e.g., an OBD-II connector that is a 16-pin connector). In some embodiments, the position-determining device 106 may provide a wireless interface to the onboard computer 116. For example, the position-determining device 106 may include an external wireless transmitter that is configured for physical coupling to an OBD-II connector in the vehicle's 118 engine compartment. The position-determining device 106, mounted in the passenger compartment of the vehicle 118, may wirelessly receive various data and other information, such as any OBD-II parameters, from the external wireless transmitter without requiring a wired connection from the passenger compartment to the engine compartment. However, in some embodiments, the position determining device 106 can be integrated with the onboard computer 116 and or use common components, e.g., share the touch screen 126.

Additionally, for vehicles lacking an onboard computer interface, the position-determining device 106 may be used to report maintenance issues associated with the vehicle. For a vehicle that lacks a output device for presenting data from the onboard computer 116, the position-determining device 106 may be used to present repair data (e.g., OBD trouble codes) that may impact the vehicle, the vehicle's fuel efficiency (e.g., a faulty oxygen sensor), and so on.

The data obtained from the onboard computer 116 may be used to calculate a real-time fuel consumption rate for the vehicle 118. For example, the fuel consumption rate in mile(s) per gallon for a gasoline fueled engine may be calculated according to the following algorithm:

$$MPG = \frac{14.7 \times 6.17 \times 454 \times ( VSS \times 0.621371 )}{\frac{3 \text{,} 600 \times MAF}{100}} = \frac{710.7 \times VSS}{MAF}$$

in which:

14.7—indicates an air to fuel ratio of 14.7 grams of air to 1 gram of gasoline (this ratio generally indicates efficient gasoline fuel combustion);

6.17—indicates a density of 6.17 pounds of gasoline per gallon (typical for gasoline between approximately 85 octane to 92 octane);

454—is a conversion rate for converting grams to pounds;

0.621371—is a conversion constant for converting from kilometers/hour to miles/hour;

3,600—indicates the number of seconds in an hour;

MAF—is the output of the mass air flow sensor;

100—indicates that typical mass flow sensor returns a rate of grams per second times 100; and

VSS is the vehicle's speed, which may be provided by the onboard computer 116 and/or independently calculated by the position-determining device 106.

In addition to VSS, each of the above-parameters may be modified by the position-determining device 106 using navigation-related information. For example, air to fuel ratio and gasoline density may vary based on temperature, altitude, and other geographic factors that may be identified by the position-determining device 106 using its location.

Similar calculations may be employed based on a type of fuel used by the vehicle (e.g., 87 octane including ethanol, 91 octane) and, as will be appreciated, the above-provided equation is only an example that may be employed in embodiments to determine real-time fuel consumption from data provided by the onboard computer 116 and innumerable equivalents and variations may be employed by the position-determining device 106.

Real-time fuel consumption rates determined or otherwise acquired by the position-determining device 106 may be used for real-time feedback to the user and/or stored within the memory 130 for use and analysis. Calculated fuel consumption rates may be used to supplement, correct, or modify the vehicle profile 134 and/or driver profile 138 to increase the accuracy of future route suggestions provided by the position-determining device 106. For example, if the vehicle profile 134 indicates that the vehicle 118 should obtain 35 miles per gallon (MPG) over a certain road type, and the real-time fuel consumption rates indicate that the vehicle has obtained only 30 MPG for the certain road type, data stored in the memory 130 may be corrected to reflect this discrepancy. Further, in embodiments that do not employ the profiles 134, 138, real-time fuel consumption rates may be used to build a model for the position-determining device 106—such as a database that correlates speed to MPG—that may be used to identify an optimum speed for the vehicle 118 and to select the “best” route from a fuel efficiency standpoint based at least in part on expected travel speed along the route. The database may be continuously and/or periodically updated by the position-determining device 106 to reflect changes in the user's vehicle, location, driving habits, and the like.

Real-time fuel consumption rates may also be geo-tagged to associate a geographic location (determined by the position-determining device 106) with an acquired fuel consumption rate. The geo-tagged fuel consumption rates may be used to generate a track log or other map interface to allow the user to view his or her driving efficiency over previously-traveled areas. For example, the user may view the track log to determine that fuel efficiency significantly dropped over a certain geographic area and then modify his or her travel and/or driving habits accordingly.

In some embodiments, where access to the onboard computer 116 is not available, the position-determining device 106 may estimate actual fuel efficiency using information provided through the input device 124. For example, the user may input the current amount of fuel in the vehicle (e.g., ½ tank or 6 gallons), when fuel is added to the vehicle, how much fuel has been added to the vehicle, combinations thereof, and the like. Using this information, the position-determining device 106 may calculate average fuel efficiency between fill ups and correlate the average fuel efficiency to driving habits, vehicle profiles, previously-visited locations, and the like. For example, the position-determining device 106 may determine that the vehicle 118 has been primarily driven over highways since the last fill up (using locations stored within the memory 130) and associate the calculated average fuel efficiency with highway travel or even the specific highways or other thoroughfares traveled by the vehicle 118. In embodiments, the position-determining device 106 may tabulate an estimated fuel efficiency based on road type driven (e.g., highway, rural road) in proportion to fuel consumption and/or a percentage of overall driving that occurred over particular road types (e.g., twenty percent of the total miles driven were on rural roads). As will be appreciated the tabulation may be associated with position related data obtained from the position-transmitting sources. To facilitate timely entry of fuel data, the position-determining device 106 may prompt the user for fuel-related inputs when the device 106 detects that it is stopped within proximity to a fuel station by accessing a points of interest database.

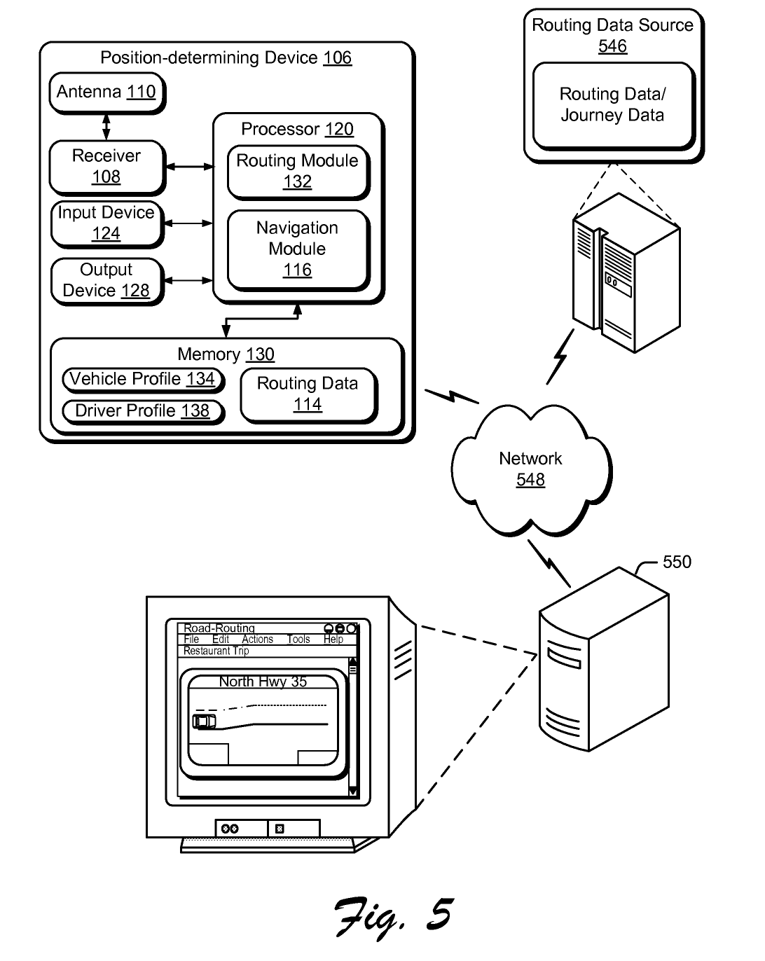

As illustrated in FIG. 5, the routing data source 546 may be web enabled to allow access over a network 548, e.g., the Internet to one or more of routing data 114, data for a journey, the vehicle profile 134, the driver profile 138, recommendations, and so on. For example, position-determining device 106 may provide the routing data source with data from the journey for analysis and/or access over the Internet. In other instances, an independent web server may be used to provide access to routing data, data from the journey, and so on. In addition to the foregoing data, the website may provide suggestions for improving driving habits, offer comparisons to other drivers, permit trip planning, customizing what routing factors are to be used by the routing module 132, customize vehicle profile characteristics, and so on. The provided data can be associated with locations based on the signals from the position-transmitting sources. In this manner, the provided data may be obtained from a networked computer 550. For example, a user may access the routing data source using the networked computer 550 to select which vehicle profile that is to be communicated to the position-determining device 106.

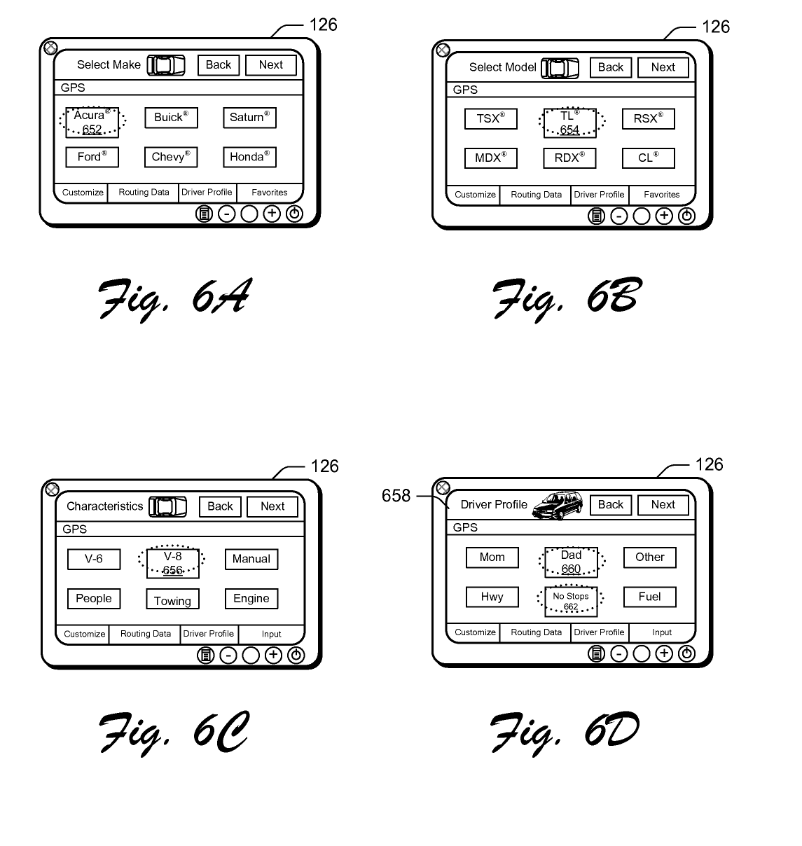

As illustrated in FIGS. 6A-D, various user interfaces (UI) may be provided to output the representation, accept user input, access the vehicle profile, and so on. While graphical user interfaces (GUIs) displayed on the touch screen 126 are illustrated, a graphical user interface (GUI) may be displayed in a variety of ways, such as on a heads-up display and so on. Although not illustrated, the processor 120 may include a user interface module for generating the GUIs and/or receiving input associated with the GUIs.

As illustrated in FIGS. 6A&B, the vehicle profile 134 may be obtained from one or more of memory 130 or the routing data source through the illustrated GUI. When the position-determining device 106 is portable, a GUI may be output to allow a user to select an appropriate vehicle profile 134 for popular vehicles, such as by selecting ACURA (American Honda Motor Company, Inc. Torrance, Calif.) and selecting the ACURA TL model (American Honda Motor Company, Inc. Torrance, Calif.). This may permit the position-determining device 106 to be associated with a variety of different vehicles. For example, in response to a user selecting the ACURA TL, respectively, 652 and 654, the position-determining device may obtain the vehicle profile 134 for the ACURA TL from one or more of memory 130 or the routing data source. When the vehicle profile is obtained from the routing data source, the profile may be stored in memory 130 for use by the routing module 132. The vehicle profile for the ACURA TL may be stored in memory 130 if the position-determining device 106 had been previously associated with an ACURA TL type vehicle.

While user input using a make and model of the vehicle is shown, in other instances the vehicle profile may be automatically downloaded from the routing data source, such as part of an initiation procedure in response to a user selecting the vehicle profile 134 over the Internet as is described with respect to FIG. 5. In further instances, the position-determining device 106 may include a receiver that is capable of associating a vehicle profile with received signals from a remote for unlocking the vehicle, such as a key fob. In the two foregoing instances, the touch screen 126 may be used to output a confirmation message and/or allow the user to confirm that the vehicle profile is correct, e.g., the GUI includes a request for a user to confirm the vehicle make and model.

As illustrated in FIG. 6C, in other instances, the GUI may be output to permit a user to customize the vehicle profile 134 and/or routing factors (not shown). For example, a user may select which vehicle characteristics are to be included in the vehicle profile, e.g., engine size (e.g., V-8 656), standard or regenerative breaking, transmission type, number of occupants, optimum speeds for fuel efficiency, and so on. This may allow the user to control which of the vehicle's features (that are associated with vehicle profile characteristics) are considered by the routing module 132.

As illustrated in FIG. 6D, aspects of the driver profile 138 may be output via the GUI presented on the touch screen 126, e.g., a driver profile GUI 658. For example, the driver profile GUI 658 may permit the driver to select a personal profile (e.g., “Dad” 660) that can be applied by the routing module 132. The driver profile GUI 658 may permit the selection of other driver related criteria, such as that the route should minimize the number of stops 662. As should be appreciated, other GUI are contemplated to output information/accept user input.

Generally, any of the functions described herein can be implemented using software, firmware, hardware (e.g., fixed logic circuitry), manual processing, or a combination of these implementations. The terms “module” and “functionality” as used herein generally represent software, firmware, hardware, or a combination thereof. In the case of a software implementation, for instance, the module represents executable instructions that perform specified tasks when executed on a processor, such as the processor 120 of the position-determining device 106 of FIG. 1. The program code can be stored in one or more computer readable media, an example of which is the memory 130 of the position-determining device 106 of FIG. 1. The features of the fuel efficient routing techniques described below are platform-independent, meaning that the techniques may be implemented on a variety of commercial computing platforms having a variety of processors.

### Exemplary Procedures

The following discussion describes fuel efficient routing techniques that may be implemented utilizing the previously described systems and devices. Aspects of each of the procedures may be implemented in hardware, firmware, software or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and/or the system 200 of FIG. 2-5.

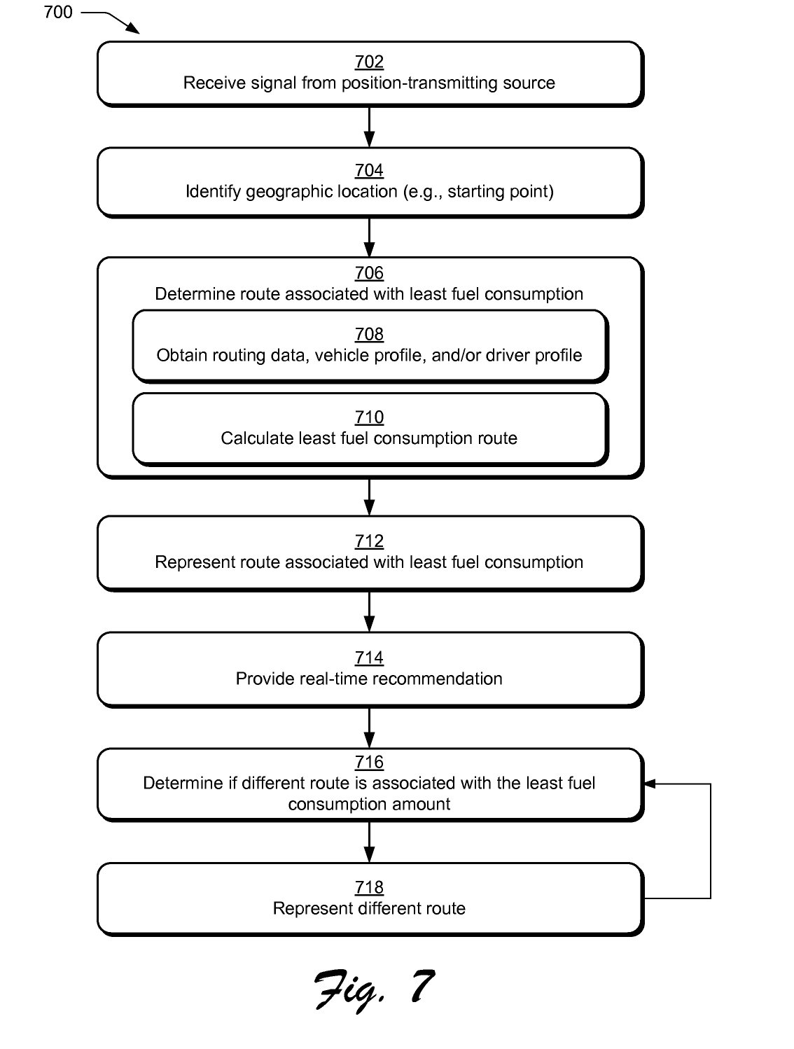

FIG. 7 depicts a procedure 700 in an exemplary implementation in which fuel efficient routing is implemented. One or more signals that can be used to identify a location are received (702). As previously described, the signals may be received from a position-transmitting source, such as a GPS source.

An identification is made as to the location (block 704). For instance, the position-determining device 106 may receive signals from the navigation satellites102 (1)-102(N) or other source. The position-determining device 106 may identify a location based upon the received signals. The identified location may be treated as a starting point for a route to a designated location. In some embodiments, the identified location may be provided through user input.

A determination is made as to which of a plurality of possible routes is associated with a least fuel consumption amount (block 706). For example, the determination may be made by comparing the fuel consumption amount for various road segments, route elements, routing factors, and so on between the identified location and the designated location based on one or more of the vehicle profile 134 or the driver profile 138.

The determination may be made by obtaining routing data, vehicle profile 134 data, driver profile data, and so on from memory and/or from the routing data source (block 708). For example, as part of determining which route is associated with the least fuel consumption amount, the vehicle profile 134 can be considered. As discussed above, the determination may be made in a stepwise manner with portions of the determination being made at various locations along the route or at different points in time.

In one or more embodiments, the determination includes calculating values for the routing factors, road segments, or the route itself (block 710). For example, an algorithm may be implemented to calculate a fuel consumption amount for the routes or the road segments, and/or routing factors impacting fuel consumption.

The route associated with the least fuel consumption amount may be represented (block 712). For example, a visual display may be presented that represents the route associated with the least fuel consumption amount. The representation may include an indication of one or more fuel consumption rates associated with segments of the route. The fuel consumption rates may be associated with different road classifications (e.g., highway, street), and so on. In some embodiments, the user may be presented the option of selecting the most-fuel efficient route or the fastest route. Upon selection, the position-determining device 106 may provide route guidance—such as turn-by-turn voice directions—to guide the user to the desired destination.

In one or more embodiments, a real-time recommendation can be provided with the representation (block 714). The recommendation may indicate an action that may be taken to reduce the fuel consumption along the route. For example, if the vehicle 118 is changing speeds along a highway, the recommendation may suggest that the driver set the cruise control to increase fuel efficiency.

A determination may be made that the represented route is not associated with the least fuel consumption amount (block 716). For example, at various points in time and/or at locations along the route, a determination may be made as to whether the “current” represented route is associated with the least fuel consumption amount. The determination at block 716 may substantially mirror the determination performed at block 708, as described above. In this case, a current location (that can be identified using the signals received from a position-transmitting source) can be substituted for the originally identified location.

Upon determining that a different route is associated with the least fuel consumption amount, a representation is made of the different route (bock 718). For instance, the representation may be changed to a route that avoids a traffic delay (e.g., a train crossing a roadway) that may result in avoidable fuel consumption. A variety of other examples are also contemplated.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A position-determining device operable for use with a vehicle, the device comprising:
a navigation signal receiver operable to receive signals from a navigation source to determine a current geographic location of the device;
a display;
a memory including data corresponding to a characteristic of the vehicle; and
a processor coupled with the navigation signal receiver, the display, and the memory, the processor operable to—
identify a fuel-efficient route to a desired destination using the vehicle characteristic data, and
present a representation of the fuel-efficient route on the display.

2. The device of claim 1, wherein the processor is operable to identify the fuel-efficient route based on a routing factor.

3. The device of claim 1, further including an interface for receiving the vehicle characteristic data from an onboard computer associated with the vehicle.

4. The device of claim 3, wherein the device is a portable navigation device and the interface includes a wireless interface for wirelessly receiving the vehicle characteristic data from a transmitter associated with an on-board diagnostics (OBD) system disposed in the vehicle's engine compartment.

5. The device of claim 3, wherein the processor is further operable to calculate a real-time fuel consumption rate for the vehicle using the received vehicle characteristic data and present a representation of the real-time fuel consumption rate on the display.

6. The device of claim 5, wherein the memory includes a vehicle profile associated with the vehicle characteristic data and the processor is operable to modify the vehicle profile based on the calculated real-time fuel consumption rate.

7. The device of claim 5, wherein the representation includes an indication of a fuel consumption rate for a segment of the identified fuel-efficient route.

8. The device of claim 5, wherein the processor is further operable to—
periodically calculate real-time fuel consumption rates for the vehicle using the received vehicle characteristic data,
associate a geographic location with at least some of the calculated real-time fuel consumption rates,
store the calculated real-time fuel consumption rates and associated geographic locations in the memory, and
present a representation of the previously-calculated real-time fuel consumption rates and associated geographic locations on the display.

9. The device of claim 1, wherein the processor is further operable to—
determine that the identified fuel-efficient route no longer would cause the vehicle to consume a lesser amount of fuel than other routes,
identify a second fuel-efficient route to the desired destination, and
present a representation of the second fuel-efficient route on the display.

10. The device of claim 1, wherein the memory includes a driver profile associated with a driver of the vehicle and the processor is operable to identify the fuel-efficient route using the vehicle configuration data and the driver profile.

11. A position-determining device operable for use with a vehicle, the device comprising:
a navigation signal receiver operable to receive signals from a navigation source to determine a current geographic location of the device;
a display;
an interface for receiving a characteristic of the vehicle from an onboard computer associated with the vehicle;
a memory including data corresponding to the received vehicle characteristic; and
a processor coupled with the navigation signal receiver, the display, the interface, and the memory, the processor operable to—
identify a fuel-efficient route to a desired destination, the fuel-efficient route being identified based on a routing factor and the vehicle characteristic data,
present a representation of the fuel-efficient route on the display, and
calculate a real-time fuel consumption rate for the vehicle using the vehicle characteristic data and present a representation of the real-time fuel consumption rate on the display.

12. The device of claim 11, wherein the device is a portable navigation device and the interface includes a wireless interface for wirelessly receiving the vehicle characteristic data from a transmitter associated with an on-board diagnostics (OBD) system disposed in the vehicle's engine compartment.

13. The device of claim 11, wherein the memory includes a vehicle profile associated with the vehicle characteristic data and the processor is operable to modify the vehicle profile based on the calculated real-time fuel consumption rate.

14. The device of claim 11, wherein the processor is further operable to—
periodically calculate real-time fuel consumption rates for the vehicle using the received vehicle characteristic data,
associate a geographic location with at least some of the calculated real-time fuel consumption rates,
store the calculated real-time fuel consumption rates and associated geographic locations in the memory, and
present a representation of the previously-calculated real-time fuel consumption rates and associated geographic locations on the display.

15. The device of claim 11, wherein the processor is further operable to—
periodically calculate real-time fuel consumption rates for the vehicle using the received vehicle characteristic data, and
identify at least one optimum speed for the vehicle using the calculated real-time fuel consumption rates.

16. The device of claim 11, wherein the processor is further operable to—
determine that the identified fuel-efficient route no longer would cause the vehicle to consume a lesser amount of fuel than other routes,
identify a second fuel-efficient route to the desired destination, and
present a representation of the second fuel-efficient route on the display.

17. The device of claim 11, wherein the memory includes a driver profile associated with a driver of the vehicle and the processor is operable to identify the fuel-efficient route using the vehicle configuration data and the driver profile.

18. A method comprising:
(a) receiving signals from a navigation source to determine a current geographic location;
(b) accessing a characteristic of a vehicle;
(c) identifying a fuel-efficient route to a desired destination using the vehicle characteristic data, and
(c) presenting a visual representation of the fuel-efficient route.

19. The method of claim 18, wherein (a) includes identifying the fuel-efficient route based on a routing factor.

20. The method of claim 18, further including receiving the vehicle characteristic from an onboard computer associated with the vehicle.

21. The method of claim 18, further including calculating a real-time fuel consumption rate for the vehicle using the vehicle characteristic and presenting a visual representation of the real-time fuel consumption rate.

22. The method of claim 21, further including—
periodically calculating real-time fuel consumption rates for the vehicle using the vehicle characteristic data,
associating a geographic location with at least some of the calculated real-time fuel consumption rates,
storing the calculated real-time fuel consumption rates and associated geographic locations, and
presenting a visual representation of the previously-calculated real-time fuel consumption rates and associated geographic locations.

23. The method of claim 18, further including—
determining that the identified fuel-efficient route no longer would cause the vehicle to consume a lesser amount of fuel than other routes,
identifying a second fuel-efficient route to the desired destination, and
presenting a visual representation of the second fuel-efficient route.

24. The method of claim 18, wherein (c) includes using a vehicle profile and a driver profile to identify the fuel-efficient route.
